(19) United States
(12) Patent Application Publication
(10) Pub. No.: US 2012/0141880 A1
(43) Pub. Date: Jun. 7, 2012

(54) IONICALLY CONDUCTIVE POLYMERS, METHODS FOR PRODUCTION THEREOF AND ELECTRICAL DEVICES MADE THEREFROM

(75) Inventors: William Patrick BURGESS, Finksburg, MD (US); Corey Adam FLEISCHER, Columbia, MD (US); Han LIU, Lutherville-Timonium, MD (US)

(73) Assignee: APPLIED NANOSTRUCTURED SOLUTIONS, LLC, Baltimore, MD (US)

(21) Appl. No.: 13/300,402

(22) Filed: Nov. 18, 2011

Related U.S. Application Data
(60) Provisional application No. 61/419,224, filed on Dec. 2, 2010.

(51) Int. Cl. H01M 10/0565; H01G 9/022; H01G 9/025; H01M 10/04; H01G 13/00; B82Y 30/00

(52) U.S. Cl. 429/306; 29/623.1; 29/25.41; 252/62.2; 361/525; 977/742

(57) ABSTRACT

The electrical conductivity of ionically conductive polymers can be increased by polymerizing a mixture of a polymer precursor and an electrolyte in the presence of an electric field. Methods for making ionically conductive polymers can include providing a mixture containing an electrolyte and a polymer precursor, and polymerizing the polymer precursor while applying an electric field to the mixture. Ionically conductive polymers so prepared can be used in electrical devices. Methods for making electrical devices containing the ionically conductive polymers are also described.

### CROSS-REFERENCE TO RELATED APPLICATIONS

This application claims the benefit of priority under 35 U.S.C. §119 from U.S. Provisional Patent Application Ser. No. 61/419,224, filed Dec. 2, 2010, which is incorporated herein by reference in its entirety.

### STATEMENT REGARDING FEDERALLY SPONSORED RESEARCH OR DEVELOPMENT

Not applicable.

### FIELD OF THE INVENTION

The present invention generally relates to conductive polymers, and, more specifically, to ionically conductive polymers containing an electrolyte and methods for production and use thereof.

### BACKGROUND

Multi-functional materials have been increasingly investigated in recent years as a result of the steadily increasing demand for consumer, industrial and military products having improved performance and functionality. Energy storage and transmission materials that can also convey mechanical strength to an article have been the subject of intense research focus in this regard. More specifically, lightweight polymers and polymer composites that can both impart mechanical strength to an article and store or transmit electrical charge have been the subject of particular research interest.

In the field of structural energy storage and transmission, solid phase electrolyte materials having good mechanical strength have been particularly sought out. Ionically conductive polymers are one type of solid phase electrolyte material having the potential to demonstrate structural energy storage and transmission capabilities. Ionically conductive polymers, sometimes referred to in the art as electrolytic polymers or electrolytic resins, can be prepared by mixing an electrolyte and a polymer matrix with one another. As used herein, the term “electrolyte” will refer to a substance that can dissociate into ions and an optional solvent medium in the ions can move. Although ionic conductivity can be imparted to a polymer matrix in this manner, it is a well recognized problem in the art that ionically conductive polymers having both high ionic conductivity values and good mechanical strength over a range of compositions can be very difficult to produce. In some cases, ionically conductive polymers can display good ionic conductivity values but be lacking in mechanical strength. In other instances, the mechanical strength of the polymers can be satisfactory, but the ionic conductivity can be lacking.

In view of the foregoing, methods for producing ionically conductive polymers having both high ionic conductivity values and improved mechanical strength would be of significant benefit in the art. Such ionically conductive polymers would be useful in a number of different applications. The present disclosure satisfies the foregoing needs and provides related advantages as well.

### SUMMARY

In some embodiments, ionically conductive polymers having an electrical conductivity of at least about 10⁻⁵ S/cm that are prepared by polymerizing a polymer precursor and an electrolyte in the presence of an electric field are described herein.

In some embodiments, electrical devices containing an ionically conductive polymer having an electrical conductivity of at least about 10⁻⁵ S/cm that are prepared by polymerizing a polymer precursor and an electrolyte in the presence of an electric field are described herein.

In some embodiments, electrical devices described herein contain a layered structure containing a first electrode layer, a second electrode layer, and a separator material layer disposed therebetween that is permeable to ions, and an ionically conductive polymer infiltrating the layered structure, where the ionically conductive polymer contains an electrolyte and a polymer matrix that has been polymerized in the presence of an electric field.

In some embodiments, methods for making an ionically conductive polymer include providing a mixture containing an electrolyte and a polymer precursor, and polymerizing the polymer precursor while applying an electric field to the mixture.

In some embodiments, methods for making an electrical device include providing a layered structure containing a first electrode layer, a second electrode layer, and a separator material layer disposed therebetween that is permeable to ions; providing a mixture containing an electrolyte and a polymer precursor; infiltrating the layered structure with the mixture; and polymerizing the polymer precursor while applying an electric field to the mixture.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1A shows a schematic of an illustrative ionically conductive polymer 2 having cations and anions 4 and 4′ dispersed therein in a substantially uniform manner; FIG. 1B shows a schematic of an illustrative ionically conductive polymer 6 having ionically conductive channels 8 with cations and anions 4 and 4′ located therein;

FIG. 2 shows a schematic of an illustrative layered electrical device containing an ionically conductive polymer prepared according to the present embodiments;

FIG. 3 shows a flow chart demonstrating how a layered electrical device can be prepared according to some of the present embodiments; and

FIG. 4 shows a schematic demonstrating an illustrative method by which a layered electrical device can be prepared according to the present embodiments.

### DETAILED DESCRIPTION

The present disclosure is directed, in part, to ionically conductive polymers and methods for production thereof. The present disclosure is also directed, in part, to electrical devices containing ionically conductive polymers and methods for production thereof.

As previously described, ionically conductive polymers prepared by conventional methods in the art oftentimes can be lacking in mechanical strength, ionic conductivity, or both. Without being bound by any theory or mechanism, the polymer matrix and the electrolyte of ionically conductive polymers are typically working against each other in establishing these properties. Remaining free from any mechanistic or theoretical constraints, it is believed that ionic conductivity in an ionically conductive polymer can arise from movement of electrolyte ions within a solvent residing in the polymer matrix. It is further believed that significant movement near the polymer chains can produce a disturbance in the polymer matrix that ultimately produces easy deformation and weak mechanical properties. In cases where the ionic conductivity is at a satisfactory level, the ionically conductive polymer can oftentimes be in a low strength gel-like state due to the quantity of electrolyte present. In such cases, if the amount of electrolyte is lowered to increase the mechanical strength, the degree of ionic conductivity can become inadequate.

It has been surprisingly discovered according to the embodiments described herein that if a polymer precursor containing an electrolyte is polymerized (cured) in the presence of an electric field, the ionic conductivity values of the resultant polymer can be significantly increased over those attainable when a comparable mixture of polymer precursor and electrolyte is polymerized together in the absence of an electric field. The embodiments described herein can advantageously allow the amount of electrolyte to be lowered in an ionically conductive polymer such that the polymer's mechanical properties can be improved.

Again without being bound by theory or mechanism, it is believed that applying an electric field to a mixture of polymer precursor and electrolyte can result in movement of the electrolyte within the polymer matrix during polymerization. It is further believed that electrolyte movement during polymerization can establish conductive ion channels within the polymer matrix that impart electrical conductivity to the resultant polymer. More specifically, it is believed that application of an electric field during polymerization can help localize the electrolyte at least partially within these conductive ion channels where it can impart ionic conductivity to the polymer and less detrimentally impact the polymer's overall mechanical strength. In conventionally produced ionically conductive polymers, it is believed that either 1) a more homogenous distribution of the electrolyte in the polymer matrix can occur, where the homogenous distribution can adversely impact the global mechanical strength of the polymer matrix, or 2) a more heterogenous distribution of the electrolyte in the polymer matrix can occur, where ionically conductive domains can be isolated from one another, thereby leading to poor ionic conductivity.

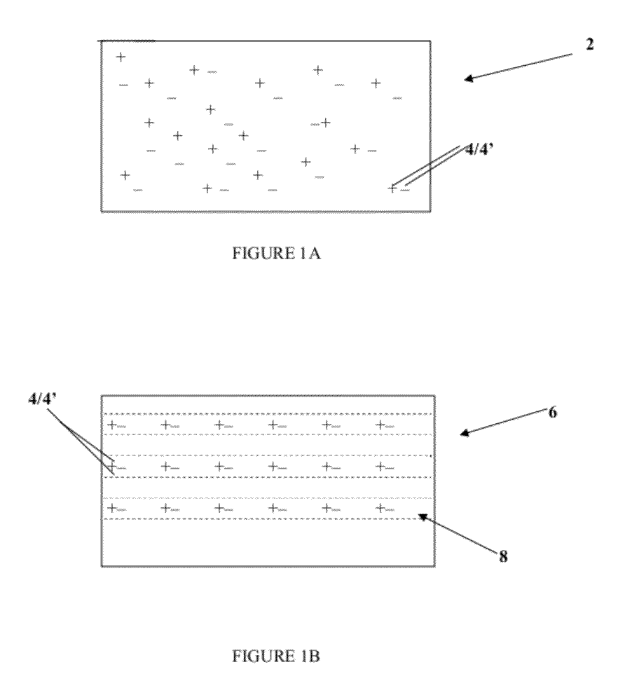

FIG. 1A shows a schematic of an illustrative ionically conductive polymer 2 having cations and anions 4 and 4′ dispersed therein in a substantially uniform manner. The ionically conductive polymer of FIG. 1A is believed to represent a potential polymer structure before application of an electric field. FIG. 1B shows a schematic of an illustrative ionically conductive polymer 6 having ionically conductive channels 8 with cations and anions 4 and 4′ located therein. The ionically conductive polymer of FIG. 1B is believed to represent a polymer structure that can be formed in the presence of an electric field. Although FIG. 1B has shown ionically conductive channels 8 to be substantially straight, it is to be recognized that the channels can be of any shape that allows current to flow therethrough.

In some embodiments, methods for making an ionically conductive polymer can include providing a mixture containing an electrolyte and a polymer precursor, and polymerizing the polymer precursor while applying an electric field to the mixture.

In general, applying an electric field to the mixture can take place by contacting electrodes with the mixture and applying a current thereto. In some embodiments, an alternating current can be applied to the mixture. However, it is to be recognized that a direct current can also be utilized, if so desired, in other embodiments.

In some embodiments, the electrolyte can be uniformly dispersed within the polymer matrix after polymerization takes place. In other embodiments, the electrolyte can be non-uniformly dispersed within the polymer matrix or dispersed in a gradient manner after polymerization takes place. In some embodiments, the electrolyte can be present within conductive ion channels within the polymer matrix of the ionically conductive polymer after polymerization takes place.

Generally, any type of polymer precursor can be used in practicing the present embodiments. In some embodiments, the polymer precursor can be an epoxy resin, which can be either a self-curing epoxy resin or a two-component epoxy resin. In some embodiments, the polymer precursor can be a polymerizable monomer leading to either a thermoplastic or thermosetting polymer. One of ordinary skill in the art will be able to choose an appropriate polymer matrix knowing the end application of the ionically conductive polymer and having the benefit of the present disclosure.

Illustrative thermoplastic polymers that can be suitable for use in the present embodiments can include, for example, polypropylene, polyethylene, polyacrylonitrile (PAN), polyvinylidine fluoride (PVDF), polystyrene, polyamides, polycarbonates, polysulfones, polyimides, polyetherimides, polyetheretherketones, polyphenylene sulfides and the like. Other suitable thermoplastic polymers can be envisioned by one having ordinary skill in the art.

Illustrative thermosetting polymers that can be suitable for use in the present embodiments can include, for example, phthalic/maleic type polyesters, vinyl esters, epoxies, phenolics, cyanates, bismaleimides, nadic end-capped polyimides (e.g., PMR-15) and the like. Other suitable thermosetting polymers can be envisioned by one having ordinary skill in the art.

In general, any type of electrolyte can be incorporated with the polymer precursor according to the present embodiments. In some embodiments, the electrolyte can be an inorganic electrolyte. In other embodiments, the electrolyte can be an organic electrolyte, including ionic liquids. One of ordinary skill in the art will recognize that the effective size of the electrolyte can influence its ionic mobility, which impact the ionic conductivity of the resultant polymer following polymerization. One having ordinary skill in the art will be able to choose an appropriate electrolyte for a given application depending upon the end application and the desired degree of ionic conductivity.

According to the present embodiments, inorganic electrolytes can include an electrolytic inorganic compound contained within an aqueous phase. Such inorganic electrolytes can include, for example, aqueous acid solutions (e.g., sulfuric acid, phosphoric acid, hydrochloric acid and the like), aqueous base solutions (e.g., sodium hydroxide, potassium hydroxide and the like), and neutral salt solutions. Illustrative salts that can be used to form a neutral salt solution can include, for example, sodium chloride, potassium chloride, sodium oxide, potassium oxide, sodium sulfate, potassium sulfate, and the like. Additional aqueous electrolytes can be envisioned by one having ordinary skill in the art. In some embodiments, the inorganic electrolyte can be an aqueous lithium ion solution. As one of ordinary skill in the art will recognize, inorganic electrolytes within an aqueous solution can offer low internal resistance values but are generally limited to an upper working voltage range of about 1 V for symmetric systems and about 2 V for asymmetric systems.

According to the present embodiments, organic electrolytes can include an electrolytic species dissolved in an organic solvent. Illustrative electrolytic species can include, for example, tetraalkylammonium salts (e.g., tetraethylammonium or tetramethylammonium halides and hydroxides); quaternary phosphonium salts; and lithium, sodium or potassium tetrafluoroborates, perchlorates, hexafluorophosphates, bis(trifluoromethane)sulfonates, bis(trifluoromethane)sulfonylimides, or tris(trifluoromethane)sulfonylmethides.

Organic solvents used in conjunction with organic electrolytes are generally aprotic organic solvents having a high dielectric constant. As one of ordinary skill in the art will recognize, organic electrolytes in such solvents can have a working voltage range of up to about 4 V but a higher internal resistance than do inorganic electrolytes in aqueous solutions. Illustrative organic solvents that can be used in conjunction with an organic electrolyte include, for example, alkyl carbonates (e.g., propylene carbonate, ethylene carbonate, butylene carbonate, dimethyl carbonate, diethyl carbonate, dipropyl carbonate, methyl ethyl carbonate, methyl butyl carbonate, methyl propyl carbonate, ethyl propyl carbonate, butyl propyl carbonate, 1,2-butylene carbonate, 2,3-butylene carbonate, 1,2-pentene carbonate, and 2,3-pentene carbonate), nitriles (e.g., acetonitrile, acrylonitrile, propionitrile, butyronitrile and benzonitrile), sulfoxides (e.g., dimethyl sulfoxide, diethyl sulfoxide, ethyl methyl sulfoxide, and benzylmethyl sulfoxide), amides (e.g., formamide, methylformamide, and dimethylformamide), pyrrolidones (e.g., N-methylpyrrolidone), lactones (e.g., γ-butyrolactone, γ-valerolactone, 2-methyl-γ-butyrolactone, and acetyl-γ-butyrolactone), phosphate triesters, nitromethane, ethers (e.g., 1,2-dimethoxyethane; 1,2-diethoxyethane; 1,2-methoxyethoxyethane; 1,2- or 1,3-dimethoxypropane; 1,2- or 1,3-diethoxypropane; 1,2- or 1,3-ethoxymethoxypropane; 1,2-dibutoxyethane; tetrahydrofuran; 2-methyltetrahydrofuran and other alkyl, dialkyl, alkoxy or dialkoxy tetrahydrofurans; 1,4-dioxane; 1,3-dioxolane; 1,4-dioxolane; 2-methyl-1,3-dioxolane; 4-methyl-1,3-dioxolane; sulfolane; 3-methylsulfolane; methyl ether; ethyl ether; propyl ether; diethylene glycol dialkyl ether; triethylene glycol dialkyl ethers; ethylene glycol dialkyl ethers; and tetraethylene glycol dialkyl ethers), esters (e.g., alkyl propionates such as methyl propionate and ethyl propionate, dialkyl malonates such as diethyl malonate, alkyl acetates such as methyl acetate and ethyl acetate, and alkyl formates such as methyl formate and ethyl formate); and maleic anhydride. In addition, organic gels and the like can be used, if desired.

In some embodiments, the electrolyte can be an ionic liquid such as, for example, benzyldimethylpropylammonium aluminum tetrachlorate, benzyldimethylammonium imide, ethylmethylammonium bisulfate, 1-butyl-3-methylimidazolium tetrafluoroborate, or tetraethylammonium tetrafluoroborate. Any of the above organic solvents can optionally be used in combination with such ionic liquids

In various embodiments, the maximum conductivity theoretically attainable when an electrolyte is dispersed in an ionically conductive polymer is the maximum conductivity of the electrolyte solution itself. That is, it is generally the case that the conductivity of the ionically conductive polymer is not greater than the conductivity of the electrolyte solution from which it is formed. As one of ordinary skill in the art will further recognize, the conductivity of the present ionically conductive polymers will be due, at least in part, to the amount of electrolyte incorporated therein. As previously described, the amount of electrolyte in an ionically conductive polymer can impact the polymer's mechanical strength. However, ionically conductive polymers prepared in accordance with the present embodiments can display enhanced conductivity values at like electrolyte concentrations, thereby resulting in better mechanical property values at the lower electrolyte concentrations.

In various embodiments, the amount of electrolyte incorporated within the present ionically conductive polymers can generally range between about 0.1% to about 90% by mass of the ionically conductive polymer. In some embodiments, the amount of the electrolyte within the present ionically conductive polymers can range between about 5% and about 90% by mass. In some embodiments, the amount of the electrolyte within the present ionically conductive polymers can range between about 10% and about 80% by mass. In some embodiments, the amount of the electrolyte within the present ionically conductive polymers can range between about 20% and about 60% by mass. In some embodiments, the amount of the electrolyte within the present ionically conductive polymers can range between about 1% and about 10% by mass. In some embodiments, the amount of the electrolyte within the present ionically conductive polymers can range between about 10% and about 20% by mass. In some embodiments, the amount of the electrolyte within the present ionically conductive polymers can range between about 20% and about 30% by mass. In some embodiments, the amount of the electrolyte within the present ionically conductive polymers can range between about 30% and about 40% by mass. In some embodiments, the amount of the electrolyte within the present ionically conductive polymers can range between about 40% and about 50% by mass. In some embodiments, the amount of the electrolyte within the present ionically conductive polymers can range between about 50% and about 60% by mass. In some embodiments, the amount of the electrolyte within the present ionically conductive polymers can range between about 60% and about 70% by mass.

As previously described, the ionic conductivity of the ionically conductive polymers can be impacted, at least in part, by the amount of electrolyte present therein. In some embodiments, the ionically conductive polymers can have a conductivity of at least about 1×10⁻⁵ S/cm. In some embodiments, the ionically conductive polymers can have a conductivity of at least about 5×10⁻⁵ S/cm. In some embodiments, the ionically conductive polymers can have a conductivity of at least about 1×10⁻⁴ S/cm. In some embodiments, the ionically conductive polymers can have a conductivity of at least about 5×10⁻⁴ S/cm. In some embodiments, the ionically conductive polymers can have a conductivity of at least about 1×10⁻³ S/cm. In some embodiments, the ionically conductive polymers can have a conductivity of at least about 5×10⁻³ S/cm. In some embodiments, the ionically conductive polymers can have a conductivity ranging between about 7.5×10⁻³ S/cm and about 1×10⁻⁴ S/cm. In some embodiments, the ionically conductive polymers can have a conductivity ranging between about 5×10⁻³ S/cm and about 1×10⁻⁴ S/cm. In some embodiments, the ionically conductive polymers can have a conductivity ranging between about 1×10⁻³ S/cm and about 1×10⁻⁴ S/cm. In some embodiments, the conductivity of the ionically conductive polymers can be at least about 25% of the maximum conductivity of the parent electrolyte solution. In some embodiments, the conductivity of the ionically conductive polymer can be at least about 10% of the maximum conductivity of the parent electrolyte solution. In some embodiments, the conductivity of the ionically conductive polymer can be at least about 5% of the maximum conductivity of the parent electrolyte solution. In some embodiments, the conductivity of the ionically conductive polymer can be at least about 1% of the maximum conductivity of the parent electrolyte solution.

In various embodiments, the ionically conductive polymers prepared according to the methods described herein can have better mechanical property values than do ionically conductive polymers made without applying an electric field while polymerizing the polymer precursor. That is, the present ionically conductive polymers can have better mechanical properties than those prepared using conventional synthetic techniques. For example, in some embodiments, the present ionically conductive polymers can have a higher compressive stiffness than does a comparable ionically conductive polymer made without applying an electric field while polymerizing the polymer precursor.

In some embodiments, the ionically conductive polymers can also contain a filler material. A number of purposes can be served by the filler material. For example, in some embodiments, the filler material can further improve the mechanical strength of the ionically conductive polymer. In other embodiments, the filler material can improve the thermal conductivity and temperature stability of the ionically conductive polymer. Suitable filler materials can include those that are conventionally used in polymer composites and can include, for example, metals, metal oxides, non-metal elements, and heteropolyacids in form of continuous fibers, chopped fibers, particulate materials (e.g., carbon black and graphite), nanoparticulate materials (e.g., metal nanoparticles, carbon nanotubes, and graphene), and the like. Fiber types can include metal fibers, ceramic fibers, organic fibers, carbon fibers, glass fibers, and the like. In some embodiments, carbon nanotube-infused fibers can be included as the filler material. Further details regarding carbon nanotube infused fibers are set forth in more detail below.

When present, the filler material can be present in the ionically conductive polymer in a non-zero amount up to about 50 wt. % of the ionically conductive polymer. In some embodiments, the filler material can be present in an amount ranging between about 0.1 wt. % and about 50 wt. %. In other embodiments, the filler material can be present in an amount ranging between about 1 wt. % and about 45 wt. %. In still other embodiments, the filler material can be present in an amount ranging between about 5 wt. % and about 40 wt. % or between about 10 wt. % and about 50 wt. %.

In other various embodiments, electrical devices are described herein that contain the ionically conductive polymers of the present disclosure. As used herein, the term “electrical device” will refer to any device that stores or transmits electrical charge. Electrical devices containing the present ionically conductive polymers can simultaneously display high levels of electrical conductivity while having better mechanical strength values than if the ionically conductive polymer is prepared without applying an electric field while polymerizing the polymer precursor. In some embodiments, electrical devices containing the present ionically conductive polymers can be in the form of a wire or conductive sheet. In some embodiments, the ionically conductive polymers described herein can replace the electrolyte of traditional batteries, electrolytic capacitors and supercapacitors.

In some embodiments, the electrical devices described herein can contain a first electrode and a second electrode. In some embodiments, electrical devices described herein can contain a first electrode and a second electrode, where an ionically conductive polymer described herein can maintain the electrodes in electrical communication with one another. In some embodiments, the electrical devices can also contain a separator material that maintains charge separation between the first electrode and the second electrode.

In some embodiments, electrical devices described herein can contain a layered structure having a first electrode layer, a second electrode layer, and a separator material layer disposed therebetween that is permeable to ions. The electrical devices can also contain an ionically conductive polymer that infiltrates the layered structure, where the ionically conductive polymer contains an electrolyte and a polymer matrix that has been polymerized in the presence of an electric field.

In some embodiments, methods for making a layered electrical device can include providing a layered structure having a first electrode layer, a second electrode layer, and a separator material layer disposed therebetween that is permeable to ions; providing a mixture containing an electrolyte and a polymer precursor; infiltrating the layered structure with the mixture; and polymerizing the polymer precursor while applying an electric field to the mixture.

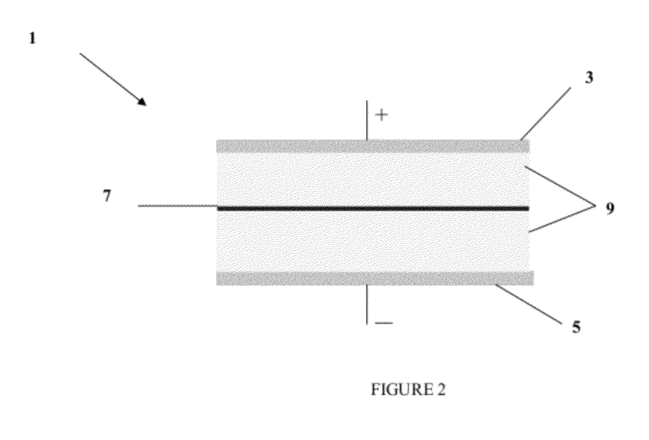

FIG. 2 shows a schematic of an illustrative layered electrical device containing an ionically conductive polymer prepared according to the present embodiments. As shown in FIG. 2, electrical device 1 contains cathode layer 3 and anode layer 5 with ionically conductive polymer 9 therebetween. Charge separation in electrical device 1 is maintained by separator material layer 7, which is permeable to ions of the electrolyte within ionically conductive polymer 9.

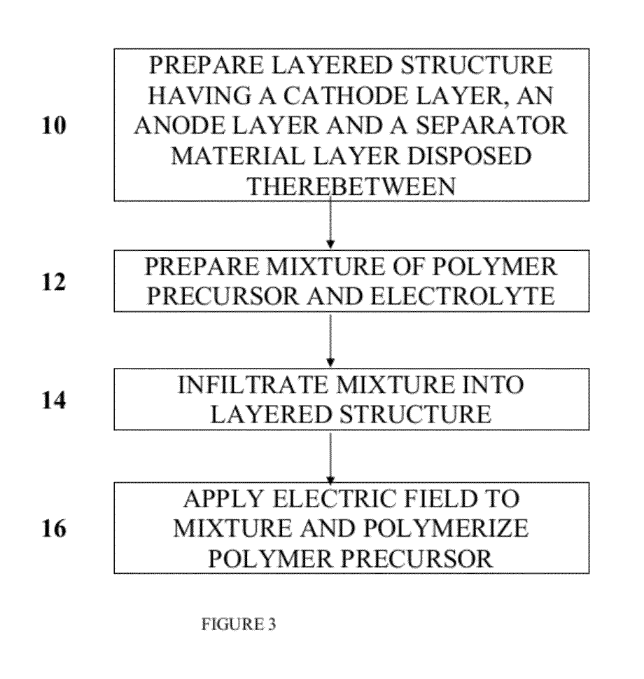

FIG. 3 shows a flow chart demonstrating how a layered electrical device can be prepared according to some of the present embodiments. As shown in FIG. 3, a layered structure having cathode layer, an anode layer and a separator material layer disposed therebetween is prepared in operation 10. In operation 12, a mixture of a polymer precursor, an electrolyte, and optionally a solvent is prepared. In operation 14, the mixture is infiltrated into the layered structure, such that the polymer precursor and the electrolyte are disposed between the cathode layer and the separator material layer and between the anode layer and the separator material layer. Finally, in operation 16, the polymer precursor is polymerized while applying an electric field to the mixture.

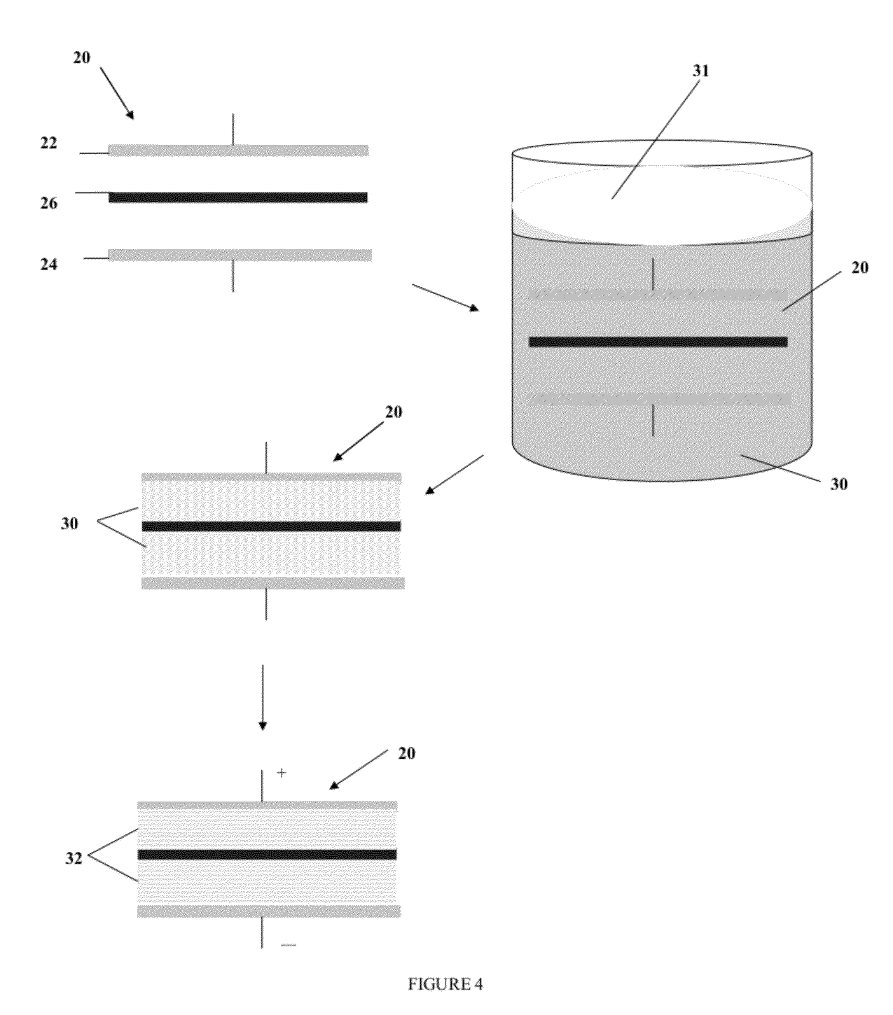

A process for preparing a layered electrical device according to the present embodiments is illustrated schematically in FIG. 4. FIG. 4 shows a schematic demonstrating an illustrative method by which a layered electrical device can be prepared according to the present embodiments. As shown in FIG. 4, layered structure 20 containing cathode layer 22, anode layer 24 and separator material layer 26 disposed therebetween is formed. In an embodiment, layered structure 20 can be prepared by simply stacking the various layers. Layered structure 20 can then be infiltrated with a mixture 30 containing a polymer precursor and an electrolyte. In an embodiment, layered structure 20 can be immersed in a reservoir 31 of mixture 30 until a satisfactory degree of penetration into layered structure 20 is achieved. Other infiltration techniques can be envisioned by one having ordinary skill in the art, including pressure infiltration or vacuum back infiltration, for example. Polymerization of the polymer precursor can then take place while applying an electric current to mixture 30 after it has infiltrated layered structure 20. For example, an alternating current can be established across cathode layer 22 and anode layer 24 to provide an electric field within mixture 30. While applying an electric field to mixture 30 within layered structure 20, the polymer can then be polymerized to form an ionically conductive polymer 32 within layered structure 20. One having ordinary skill in the art will recognize appropriate polymerization techniques that will be suitable for a particular polymer precursor. For example, in various embodiments, polymerization of the polymer precursor can be initiated by heating, addition of an initiator, or through photoinitiation.

The separator material of the electrical devices can be formed from any substance of sufficient thickness that is capable of maintaining charge separation of the electrolyte ions once a charged state is attained. In general, the separator material can be a thin film dielectric substance that is porous in nature and allows for high ion mobility between the electrode materials when the electrical device is charging or discharging, but is capable of maintaining charge separation once the electrical device reaches a charged state. Thus, the separator material can be selectively permeable to charge carriers of an electrolyte. In some embodiments, the separator material can be a non-woven polymer fabric such as, for example, polyethylene non-woven fabrics, polypropylene non-woven fabrics, polyester non-woven fabrics, and polyacrylonitrile non-woven fabrics. In other embodiments, the separator material can be a porous substance such as, for example, a porous poly(vinylidene fluoride)-hexafluoropropane copolymer film, a porous cellulose film, kraft paper, rayon woven fabrics, and the like. Generally, any separator material that can be used in batteries can also be used in the present embodiments for a like purpose.

The degree of porosity of the separator material is such that the ions of the electrolyte are sufficiently mobile so as to move across the separator material when the device is being charged or discharged but sufficiently immobile so as to maintain charge separation once the device reaches a charged state. In some embodiments, the porosity of the separator material can be greater than about 90%. In some embodiments, the porosity of the separator material can range between about 90% and about 95%. In other embodiments, the porosity of the separator material can range between about 90% and about 40%, or between about 87% and about 50%, or between about 85% and about 65%.

In addition to porosity, the thickness of the separator material layer can govern the degree of ion mobility across the separator material. For a given porosity, a thicker separator material generally can provide a greater degree of shorting protection and lower ion mobility than does a thinner separator material. In some embodiments, the thickness of the separator material layer can be less than about 100 μm. In some embodiments, the thickness of the separator material layer can range between about 100 μm and about 50 μm. In some embodiments, the thickness of the separator material layer can range between about 50 μm and about 25 μm or between about 25 μm and about 10 μm. In some embodiments, the thickness of the separator material layer can be less than about 10 μm. In some embodiments, the thickness of the separator material layer can range between about 10 μm and about 1 μm. In some embodiments, the thickness of separator material layer can be less than about 1 μm. In some embodiments, the thickness of the separator material layer can range between about 100 nm and about 1 μm.

In one embodiment, a suitable separator material can be a high porosity (e.g., >90%) polypropylene and/or polyethylene electrolytic membrane. Such electrolytic membranes are available from Celgard LLC of Charlotte, N.C. These electrolytic membranes exhibit a high electric voltage standoff capability, thereby permitting a thinner and lighter film for isolating the electrode materials. In some embodiments, a cellulosic fiber separator material (e.g., kraft paper) or a nonwoven polymeric mat (e.g., polyimide fiber separator) can also be used.

Some embodiments herein can utilize carbon nanotube-infused fibers. Illustrative carbon nanotube-infused fibers are described in more detail in commonly owned U.S. patent application Ser. Nos. 12/611,073, 12/611,101 and 12/611,103, each filed on Nov. 2, 2009 and incorporated herein by reference in its entirety. Further details of carbon nanotube-infused fibers and processes for their production follow below. In some embodiments, carbon nanotube-infused fibers can be present as a filler material within the ionically conductive polymer. In some or other embodiments, carbon nanotube-infused fibers can be used in at least one electrode layer within an electrical device containing an ionically conductive polymer of the present disclosure. Illustrative electrical devices containing carbon nanotube-infused fibers are described in commonly owned U.S. patent applications 13/039,025 and 13/039,028, each filed Mar. 2, 2011, and 13/117,071, filed May 26, 2011, each of which is incorporated herein by reference in its entirety. It is to be recognized that the electrical device configurations described in these patent applications are for purposes of illustration only, and the described configurations can be readily modified by one having ordinary skill in the art.

As used herein, the terms “fiber,” “fiber material,” or “filament” equivalently refer to any material that has a fibrous component as a basic structural feature. As used herein, the term “continuous fibers” refers to spoolable lengths of fiber materials such as individual filaments, yarns, rovings, tows, tapes, ribbons, woven and non-woven fabrics, plies, mats, and the like.

As used herein, the terms “spoolable lengths” or “spoolable dimensions” equivalently refer to a fiber material that has at least one dimension that is not limited in length, thereby allowing the fiber material to be stored on a spool or mandrel following infusion with carbon nanotubes. A fiber material of “spoolable lengths” or “spoolable dimensions” has at least one dimension that indicates the use of either batch or continuous processing for carbon nanotube infusion thereon.

As used herein, the term “infused” refers to being bonded and “infusion” refers to the process of bonding. As used herein, the terms “carbon nanotube-infused fiber” or “carbon nanotube-infused fiber material” equivalently refer to a fiber material that has carbon nanotubes bonded thereto. Such bonding of carbon nanotubes to a fiber material can involve mechanical attachment, covalent bonding, ionic bonding, pi-pi interactions (pi-stacking interactions), and/or van der Waals force-mediated physisorption. In some embodiments, the carbon nanotubes can be directly bonded to the fiber material. In other embodiments, the carbon nanotubes can be indirectly bonded to the fiber material via a barrier coating and/or catalytic nanoparticles used to mediate growth of the carbon nanotubes. The particular manner in which the carbon nanotubes are infused to the fiber material can be referred to as the bonding motif.

As used herein, the term “nanoparticle” refers to particles having a diameter between about 0.1 nm and about 100 nm in equivalent spherical diameter, although nanoparticles need not necessarily be spherical in shape. As used herein, the term “catalytic nanoparticle” refers to a nanoparticle that possesses catalytic activity for mediating carbon nanotube growth.

As used herein, the terms “sizing agent,” or “sizing,” collectively refer to materials used in the manufacture of fiber materials as a coating to protect the integrity of the fiber material, to provide enhanced interfacial interactions between the fiber material and a matrix material, and/or to alter and/or to enhance certain physical properties of the fiber material.

The fiber material of carbon nanotube-infused fibers can generally vary without limitation and can include, for example, glass fibers, carbon fibers, metal fibers, ceramic fibers, and organic fibers (e.g., aramid fibers) for example. Such carbon nanotube-infused fibers can be readily prepared in spoolable lengths from commercially available continuous fibers or continuous fiber forms (e.g., fiber tows or fiber tapes). In addition, the carbon nanotubes' lengths, diameter, and coverage density can readily be varied by the above-referenced methods.

Depending on their growth conditions, the carbon nanotubes of the carbon nanotube-infused fibers can also be oriented such that they are substantially perpendicular to the surface of the fiber material or such that they are substantially parallel to the longitudinal axis of the fiber material. In the present embodiments, by using carbon nanotube-infused fibers having substantially perpendicular carbon nanotubes, a better exposure of an electrolyte to the carbon nanotube surface area can be realized. This is particularly true, when the carbon nanotubes are present in a substantially unbundled state. The above-referenced methods for preparing carbon nanotube-infused fibers are particularly adept at achieving a substantially perpendicular orientation and a substantially unbundled state, thereby providing carbon nanotube-infused fibers having a high effective surface area for use in the present embodiments.

In various embodiments, the carbon nanotubes can have a length ranging between about 1 μm and about 1000 μm or between about 1 μm and about 500 μm. In some embodiments, the carbon nanotubes can have a length ranging between about 100 μm and about 500 μm. In other embodiments, the carbon nanotubes can have a length ranging between about 1 μm and about 50 μm or between about 10 μm and about 25 μm. In some embodiments, the carbon nanotubes can be substantially uniform in length.

To infuse carbon nanotubes to a fiber material, the carbon nanotubes are synthesized directly on the fiber material. In some embodiments, this is accomplished by first disposing a carbon nanotube-forming catalyst (e.g., catalytic nanoparticles) on the fiber material. A number of preparatory processes can be performed prior to this catalyst deposition.

In some embodiments, the fiber material can be optionally treated with a plasma to prepare the fiber surface to accept the catalyst. For example, a plasma treated glass fiber material can provide a roughened glass fiber surface in which the carbon nanotube-forming catalyst can be deposited. In some embodiments, the plasma also serves to “clean” the fiber surface. The plasma process for “roughing” the fiber surface thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, ammonia, nitrogen and hydrogen. In addition, the plasma treatment of the fiber surface can add functional groups thereto that can be useful in some embodiments.

In some embodiments, where a fiber material being employed has a sizing material associated with it, such sizing can be optionally removed prior to catalyst deposition. Optionally, the sizing material can be removed after catalyst deposition. In some embodiments, sizing material removal can be accomplished during carbon nanotube synthesis or just prior to carbon nanotube synthesis in a pre-heat step. In other embodiments, some sizing materials can remain throughout the entire carbon nanotube synthesis process.

Yet another optional step prior to or concomitant with deposition of the carbon nanotube-forming catalyst (i.e., catalytic nanoparticles) is application of a barrier coating on the fiber material. Barrier coatings are materials designed to protect the integrity of sensitive fiber materials, such as carbon fibers, organic fibers, glass fibers, metal fibers, and the like. Such barrier coatings can include, for example, an alkoxysilane, an alumoxane, alumina nanoparticles, spin on glass and glass nanoparticles. For example, in an embodiment the barrier coating is Accuglass T-11 Spin-On Glass (Honeywell International Inc., Morristown, N.J.). The carbon nanotube-forming catalyst can be added to the uncured barrier coating material and then applied to the fiber material together, in one embodiment. In other embodiments, the barrier coating material can be added to the fiber material prior to deposition of the carbon nanotube-forming catalyst. In such embodiments, the barrier coating can be partially cured prior to catalyst deposition. The barrier coating material can be of a sufficiently thin thickness to allow exposure of the carbon nanotube-forming catalyst to the carbon feedstock gas for subsequent CVD- or like carbon nanotube growth. In some embodiments, the barrier coating thickness is less than or about equal to the effective diameter of the carbon nanotube-forming catalyst. Once the carbon nanotube-forming catalyst and the barrier coating are in place, the barrier coating can be fully cured. In some embodiments, the thickness of the barrier coating can be greater than the effective diameter of the carbon nanotube-forming catalyst so long as it still permits access of carbon nanotube feedstock gases to the sites of the catalyst. Such barrier coatings can be sufficiently porous to allow access of carbon feedstock gases to the carbon nanotube-forming catalyst.

In some embodiments, the thickness of the barrier coating can range between about 10 nm and about 100 nm. In other embodiments, the thickness of the barrier coating can range between about 10 nm and about 50 nm, including 40 nm. In some embodiments, the thickness of the barrier coating can be less than about 10 nm, including about 1 nm, about 2 nm, about 3 nm, about 4 nm, about 5 nm, about 6 nm, about 7 nm, about 8 nm, about 9 nm, and about 10 nm, including all values and subranges therebetween.

Without being bound by theory, the barrier coating can serve as an intermediate layer between the fiber material and the carbon nanotubes and mechanically infuses the carbon nanotubes to the fiber material. Such mechanical infusion via a barrier coating can provide a robust system for carbon nanotube growth in which the fiber material serves as a platform for organizing the carbon nanotubes, while still allowing the beneficial carbon nanotube properties to be conveyed to the fiber material. Moreover, benefits of including a barrier coating can include, for example, protection of the fiber material from chemical damage due to moisture exposure and/or thermal damage at the elevated temperatures used to promote carbon nanotube growth.

As described further below, the carbon nanotube-forming catalyst can be prepared as a liquid solution that contains the carbon nanotube-forming catalyst as transition metal catalytic nanoparticles. The diameters of the synthesized carbon nanotubes are related to the size of the transition metal catalytic nanoparticles as described above.

Carbon nanotube synthesis can be based on a chemical vapor deposition (CVD) process or related carbon nanotube growth process which occurs at elevated temperatures. In some embodiments, the CVD-based growth process can be plasma-enhanced by providing an electric field during the growth process such that the carbon nanotube growth follows the direction of the electric field. Other illustrative carbon nanotube growth processes can include, for example, micro-cavity, laser ablation, flame synthesis, arc discharge, and high pressure carbon monoxide (HiPCO) synthesis. The specific temperature is a function of catalyst choice, but can typically be in a range of about 500° C. to about 1000° C. Accordingly, carbon nanotube synthesis involves heating the fiber material to a temperature in the aforementioned range to support carbon nanotube growth.

In some embodiments, CVD-promoted carbon nanotube growth on the catalyst-laden fiber material can be performed. The CVD process can be promoted by, for example, a carbon-containing feedstock gas such as acetylene, ethylene, and/or ethanol. The carbon nanotube growth processes also generally use an inert gas (e.g., nitrogen, argon, and/or helium) as a primary carrier gas. The carbon-containing feedstock gas can typically provided in a range from between about 1% to about 50% of the total mixture. A substantially inert environment for CVD growth can be prepared by removal of moisture and oxygen from the growth chamber.

In the carbon nanotube growth process, carbon nanotubes grow at the sites of transition metal catalytic nanoparticles that are operable for carbon nanotube growth. The presence of a strong plasma-creating electric field can be optionally employed to affect carbon nanotube growth. That is, the growth tends to follow the direction of the electric field. By properly adjusting the geometry of the plasma spray and electric field, vertically aligned carbon nanotubes (i.e., perpendicular to the surface of the fiber material) can be synthesized. Under certain conditions, even in the absence of a plasma, closely-spaced carbon nanotubes can maintain a substantially vertical growth direction resulting in a dense array of carbon nanotubes resembling a carpet or forest.

Returning to the catalyst deposition process, a carbon nanotube-forming catalyst can be deposited to provide a layer (typically no more than a monolayer) of catalytic nanoparticles on the fiber material for the purpose of growing carbon nanotubes thereon. The operation of depositing catalytic nanoparticles on the fiber material can be accomplished by a number of techniques including, for example, spraying or dip coating a solution of catalytic nanoparticles or by gas phase deposition, which can occur by a plasma process. Thus, in some embodiments, after forming a catalyst solution in a solvent, the catalyst can be applied by spraying or dip coating the fiber material with the solution, or combinations of spraying and dip coating. Either technique, used alone or in combination, can be employed once, twice, thrice, four times, up to any number of times to provide a fiber material that is sufficiently uniformly coated with catalytic nanoparticles that are operable for formation of carbon nanotubes. When dip coating is employed, for example, a fiber material can be placed in a first dip bath for a first residence time in the first dip bath. When employing a second dip bath, the fiber material can be placed in the second dip bath for a second residence time. For example, fiber materials can be subjected to a solution of carbon nanotube-forming catalyst for between about 3 seconds to about 90 seconds depending on the dip configuration and linespeed. Employing spraying or dip coating processes, a fiber material with a catalyst surface density of less than about 5% surface coverage to as high as about 80% surface coverage can be obtained. At higher surface densities (e.g., about 80%), the carbon nanotube-forming catalyst nanoparticles are nearly a monolayer. In some embodiments, the process of coating the carbon nanotube-forming catalyst on the fiber material produces no more than a monolayer. For example, carbon nanotube growth on a stack of carbon nanotube-forming catalyst can erode the degree of infusion of the carbon nanotubes to the fiber material. In other embodiments, transition metal catalytic nanoparticles can be deposited on the fiber material using evaporation techniques, electrolytic deposition techniques, and other processes known to those of ordinary skill in the art, such as addition of the transition metal catalyst to a plasma feedstock gas as a metal organic, metal salt or other composition promoting gas phase transport.

Because processes to manufacture carbon nanotube-infused fibers are designed to be continuous, a spoolable fiber material can be dip-coated in a series of baths where dip coating baths are spatially separated. In a continuous process in which nascent fibers are being generated de novo, such as newly formed glass fibers from a furnace, dip bath or spraying of a carbon nanotube-forming catalyst can be the first step after sufficiently cooling the newly formed fiber material. In some embodiments, cooling of newly formed glass fibers can be accomplished with a cooling jet of water which has the carbon nanotube-forming catalyst particles dispersed therein.

In some embodiments, application of a carbon nanotube-forming catalyst can be performed in lieu of application of a sizing when generating a fiber and infusing it with carbon nanotubes in a continuous process. In other embodiments, the carbon nanotube-forming catalyst can be applied to newly formed fiber materials in the presence of other sizing agents. Such simultaneous application of a carbon nanotube-forming catalyst and other sizing agents can provide the carbon nanotube-forming catalyst in surface contact with the fiber material to insure carbon nanotube infusion. In yet further embodiments, the carbon nanotube-forming catalyst can be applied to nascent fibers by spray or dip coating while the fiber material is in a sufficiently softened state, for example, near or below the annealing temperature, such that the carbon nanotube-forming catalyst is slightly embedded in the surface of the fiber material. When depositing the carbon nanotube-forming catalyst on hot glass fiber materials, for example, care should be given to not exceed the melting point of the carbon nanotube-forming catalyst, thereby causing nanoparticle fusion and loss of control of the carbon nanotube characteristics (e.g., diameter) as a result.

Carbon nanotubes infused to a fiber material can serve to protect the fiber material from conditions including, for example, moisture, oxidation, abrasion, compression and/or other environmental conditions. In this case, the carbon nanotubes themselves can act as a sizing agent. Such a carbon nanotube-based sizing agent can be applied to a fiber material in lieu of or in addition to conventional sizing agents. When present, conventional sizing agents can be applied before or after the infusion and growth of carbon nanotubes on the fiber material. Conventional sizing agents vary widely in type and function and include, for example, surfactants, anti-static agents, lubricants, siloxanes, alkoxysilanes, aminosilanes, silanes, silanols, polyvinyl alcohol, starch, and mixtures thereof. Such conventional sizing agents can be used to protect the carbon nanotubes themselves from various conditions or to convey further properties to the fiber material that are not imparted by the carbon nanotubes. In some embodiments, a conventional sizing agent can be removed from the fiber material prior to carbon nanotube growth. Optionally, a conventional sizing agent can be replaced with another conventional sizing agent that is more compatible with the carbon nanotubes or the carbon nanotube growth conditions.

The carbon nanotube-forming catalyst solution can be a transition metal nanoparticle solution of any d-block transition metal. In addition, the nanoparticles can include alloys and non-alloy mixtures of d-block metals in elemental form, in salt form, and mixtures thereof. Such salt forms include, without limitation, oxides, carbides, nitrides, nitrates, sulfides, sulfates, phosphates, halides (e.g., fluorides, chlorides, bromides, and iodides), acetates and the like. Non-limiting illustrative transition metal nanoparticles include, for example, Ni, Fe, Co, Mo, Cu, Pt, Au, and Ag, salts thereof and mixtures thereof. Many transition metal nanoparticle catalysts are readily commercially available from a variety of suppliers, including, for example, Ferrotec Corporation (Bedford, N.H.).

Catalyst solutions used for applying the carbon nanotube-forming catalyst to the fiber material can be in any common solvent that allows the carbon nanotube-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the carbon nanotube-forming catalytic nanoparticles therein. Concentrations of carbon nanotube-forming catalyst in the catalyst solution can be in a range from about 1:1 to about 1:10,000 catalyst to solvent.

In some embodiments, after applying the carbon nanotube-forming catalyst to the fiber material, the fiber material can be optionally heated to a softening temperature. This step can aid in embedding the carbon nanotube-forming catalyst in the surface of the fiber material to encourage seeded growth and prevent tip growth where the catalyst floats at the tip of the leading edge a growing carbon nanotube. In some embodiments heating of the fiber material after disposing the carbon nanotube-forming catalyst on the fiber material can be at a temperature between about 500° C. and about 1000° C. Heating to such temperatures, which can be used for carbon nanotube growth, can serve to remove any pre-existing sizing agents on the fiber material allowing deposition of the carbon nanotube-forming catalyst directly on the fiber material. In some embodiments, the carbon nanotube-forming catalyst can also be placed on the surface of a sizing coating prior to heating. The heating step can be used to remove sizing material while leaving the carbon nanotube-forming catalyst disposed on the surface of the fiber material. Heating at these temperatures can be performed prior to or substantially simultaneously with introduction of a carbon-containing feedstock gas for carbon nanotube growth.

In some embodiments, the process of infusing carbon nanotubes to a fiber material can include removing sizing agents from the fiber material, applying a carbon nanotube-forming catalyst to the fiber material after sizing removal, heating the fiber material to at least about 500° C., and synthesizing carbon nanotubes on the fiber material. In some embodiments, operations of the carbon nanotube infusion process can include removing sizing from a fiber material, applying a carbon nanotube-forming catalyst to the fiber material, heating the fiber material to a temperature operable for carbon nanotube synthesis and spraying a carbon plasma onto the catalyst-laden fiber material. Thus, where commercial fiber materials are employed, processes for constructing carbon nanotube-infused fibers can include a discrete step of removing sizing from the fiber material before disposing the catalytic nanoparticles on the fiber material. Some commercial sizing materials, if present, can prevent surface contact of the carbon nanotube-forming catalyst with the fiber material and inhibit carbon nanotube infusion to the fiber material. In some embodiments, where sizing removal is assured under carbon nanotube growth conditions, sizing removal can be performed after deposition of the carbon nanotube-forming catalyst but just prior to or during providing a carbon-containing feedstock gas.

The step of synthesizing carbon nanotubes can include numerous techniques for forming carbon nanotubes, including, without limitation, micro-cavity, thermal or plasma-enhanced CVD techniques, laser ablation, arc discharge, flame synthesis, and high pressure carbon monoxide (HiPCO). During CVD, in particular, a sized fiber material with carbon nanotube-forming catalyst disposed thereon, can be used directly. In some embodiments, any conventional sizing agents can be removed during carbon nanotube synthesis. In some embodiments other sizing agents are not removed, but do not hinder carbon nanotube synthesis and infusion to the fiber material due to the diffusion of the carbon-containing feedstock gas through the sizing. In some embodiments, acetylene gas can be ionized to create a jet of cold carbon plasma for carbon nanotube synthesis. The plasma is directed toward the catalyst-laden fiber material. Thus, in some embodiments synthesizing carbon nanotubes on a fiber material includes (a) forming a carbon plasma; and (b) directing the carbon plasma onto the catalyst disposed on the fiber material. The diameters of the carbon nanotubes that are grown are dictated by the size of the carbon nanotube-forming catalyst. In some embodiments, a sized fiber material can be heated to between about 550° C. and about 800° C. to facilitate carbon nanotube growth. To initiate the growth of carbon nanotubes, two or more gases are bled into the reactor: an inert carrier gas (e.g., argon, helium, or nitrogen) and a carbon-containing feedstock gas (e.g., acetylene, ethylene, ethanol or methane). Carbon nanotubes grow at the sites of the carbon nanotube-forming catalyst.

In some embodiments, a CVD growth process can be plasma-enhanced. A plasma can be generated by providing an electric field during the growth process. Carbon nanotubes grown under these conditions can follow the direction of the electric field. Thus, by adjusting the geometry of the reactor, vertically aligned carbon nanotubes can be grown where the carbon nanotubes are substantially perpendicular to the surface of the fiber material (i.e., radial growth). In some embodiments, a plasma is not required for radial growth to occur about the fiber material. For fiber materials that have distinct sides such as, for example, tapes, mats, fabrics, plies, and the like, the carbon nanotube-forming catalyst can be disposed on one or both sides of the fiber material. Correspondingly, under such conditions, carbon nanotubes can be grown on one or both sides of the fiber material as well.

As described above, the carbon nanotube synthesis is performed at a rate sufficient to provide a continuous process for infusing spoolable length fiber materials with carbon nanotubes. Numerous apparatus configurations facilitate such a continuous synthesis.

In some embodiments, carbon nanotube-infused fiber materials can be prepared in an “all-plasma” process. In such embodiments, the fiber materials pass through numerous plasma-mediated steps to form the final carbon nanotube-infused fiber materials. The first of the plasma processes, can include a step of fiber surface modification. This is a plasma process for “roughing” the surface of the fiber material to facilitate catalyst deposition, as described above. Optionally, a functionalization of the fiber material can also be involved. As also described above, surface modification can be achieved using a plasma of any one or more of a variety of different gases, including, without limitation, argon, helium, oxygen, ammonia, hydrogen, and nitrogen.

After surface modification, the fiber material proceeds to catalyst application. In the present all-plasma process, this step is a plasma process for depositing the carbon nanotube-forming catalyst on the fiber material. The carbon nanotube-forming catalyst is typically a transition metal as described above. The transition metal catalyst can be added to a plasma feedstock gas as a precursor in non-limiting forms including, for example, a ferrofluid, a metal organic, a metal salt, mixtures thereof or any other composition suitable for promoting gas phase transport. The carbon nanotube-forming catalyst can be applied at room temperature in ambient environment with neither vacuum nor an inert atmosphere being required. In some embodiments, the fiber material can be cooled prior to catalyst application.

Continuing the all-plasma process, carbon nanotube synthesis can occur in a carbon nanotube-growth reactor. Carbon nanotube growth can be achieved through the use of plasma-enhanced chemical vapor deposition, wherein carbon plasma is sprayed onto the catalyst-laden fibers. Since carbon nanotube growth occurs at elevated temperatures (typically in a range of about 500° C. to about 1000° C. depending on the catalyst), the catalyst-laden fibers can be heated prior to being exposed to the carbon plasma. For the carbon nanotube infusion process, the fiber material can be optionally heated until softening occurs. After heating, the fiber material is ready to receive the carbon plasma. The carbon plasma can be generated, for example, by passing a carbon-containing feedstock gas such as, for example, acetylene, ethylene, ethanol, and the like, through an electric field that is capable of ionizing the gas. This cold carbon plasma is directed, via spray nozzles, to the fiber material. The fiber material can be in close proximity to the spray nozzles, such as within about 1 centimeter of the spray nozzles, to receive the plasma. In some embodiments, heaters can be disposed above the fiber material at the plasma sprayers to maintain the elevated temperature of the fiber material.

Another configuration for continuous carbon nanotube synthesis involves a special rectangular reactor for the synthesis and growth of carbon nanotubes directly on fiber materials. The reactor can be designed for use in a continuous in-line process for producing carbon nanotube-infused fiber materials. In some embodiments, carbon nanotubes are grown via a CVD process at atmospheric pressure and an elevated temperature in the range of about 550° C. and about 800° C. in a multi-zone reactor. The fact that the carbon nanotube synthesis occurs at atmospheric pressure is one factor that facilitates the incorporation of the reactor into a continuous processing line for carbon nanotube infusion to the fiber materials. Another advantage consistent with in-line continuous processing using such a zone reactor is that carbon nanotube growth occurs in seconds, as opposed to minutes (or longer), as in other procedures and apparatus configurations typical in the art.

Carbon nanotube synthesis reactors in accordance with the various embodiments include the following features:

Rectangular Configured Synthesis Reactors: The cross-section of a typical carbon nanotube synthesis reactor known in the art is circular. There are a number of reasons for this including, for example, historical reasons (e.g., cylindrical reactors are often used in laboratories) and convenience (e.g., flow dynamics are easy to model in cylindrical reactors, heater systems readily accept circular tubes (e.g., quartz, etc.), and ease of manufacturing. Departing from the cylindrical convention, the present disclosure provides a carbon nanotube synthesis reactor having a rectangular cross section. The reasons for the departure include at least the following:

1) Inefficient Use of Reactor Volume. Since many fiber materials that can be processed by the reactor are relatively planar (e.g., flat tapes, sheet-like forms, or spread tows or rovings), a circular cross-section is an inefficient use of the reactor volume. This inefficiency results in several drawbacks for cylindrical carbon nanotube synthesis reactors including, for example, a) maintaining a sufficient system purge; increased reactor volume requires increased gas flow rates to maintain the same level of gas purge, resulting in inefficiencies for high volume production of carbon nanotubes in an open environment; b) increased carbon-containing feedstock gas flow rates; the relative increase in inert gas flow for system purge, as per a) above, requires increased carbon-containing feedstock gas flow rates. Consider that the volume of an illustrative 12K glass fiber roving is about 2000 times less than the total volume of a synthesis reactor having a rectangular cross-section. In an equivalent cylindrical reactor (i.e., a cylindrical reactor that has a width that accommodates the same planarized glass fiber material as the rectangular cross-section reactor), the volume of the glass fiber material is about 17,500 times less than the volume of the reactor. Although gas deposition processes, such as CVD, are typically governed by pressure and temperature alone, volume can have a significant impact on the efficiency of deposition. With a rectangular reactor there is a still excess volume, and this excess volume facilitates unwanted reactions. However, a cylindrical reactor has about eight times that volume available for facilitating unwanted reactions. Due to this greater opportunity for competing reactions to occur, the desired reactions effectively occur more slowly in a cylindrical reactor. Such a slow down in carbon nanotube growth, is problematic for the development of continuous growth processes. Another benefit of a rectangular reactor configuration is that the reactor volume can be decreased further still by using a small height for the rectangular chamber to make the volume ratio better and the reactions even more efficient. In some embodiments disclosed herein, the total volume of a rectangular synthesis reactor is no more than about 3000 times greater than the total volume of a fiber material being passed through the synthesis reactor. In some further embodiments, the total volume of the rectangular synthesis reactor is no more than about 4000 times greater than the total volume of the fiber material being passed through the synthesis reactor. In some still further embodiments, the total volume of the rectangular synthesis reactor is less than about 10,000 times greater than the total volume of the fiber material being passed through the synthesis reactor. Additionally, it is notable that when using a cylindrical reactor, more carbon-containing feedstock gas is required to provide the same flow percent as compared to reactors having a rectangular cross section. It should be appreciated that in some other embodiments, the synthesis reactor has a cross-section that is described by polygonal forms that are not rectangular, but are relatively similar thereto and provide a similar reduction in reactor volume relative to a reactor having a circular cross section; and c) problematic temperature distribution; when a relatively small-diameter reactor is used, the temperature gradient from the center of the chamber to the walls thereof is minimal, but with increased reactor size, such as would be used for commercial-scale production, such temperature gradients increase. Temperature gradients result in product quality variations across the fiber material (i.e., product quality varies as a function of radial position). This problem is substantially avoided when using a reactor having a rectangular cross-section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided.

2) Gas introduction. Because tubular furnaces are normally employed in the art, typical carbon nanotube synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall carbon nanotube growth rate because the incoming feedstock gas is continuously replenishing at the hottest portion of the system, which is where carbon nanotube growth is most active.

Zoning. Chambers that provide a relatively cool purge zone extend from both ends of the rectangular synthesis reactor. Applicants have determined that if a hot gas were to mix with the external environment (i.e., outside of the rectangular reactor), there would be increased degradation of the fiber material. The cool purge zones provide a buffer between the internal system and external environments. Carbon nanotube synthesis reactor configurations known in the art typically require that the substrate is carefully (and slowly) cooled. The cool purge zone at the exit of the present rectangular carbon nanotube growth reactor achieves the cooling in a short period of time, as required for continuous in-line processing.

Non-contact, hot-walled, metallic reactor. In some embodiments, a metallic hot-walled reactor (e.g., stainless steel) is employed. Use of this type of reactor can appear counterintuitive because metal, and stainless steel in particular, is more susceptible to carbon deposition (i.e., soot and by-product formation). Thus, most carbon nanotube synthesis reactors are made from quartz because there is less carbon deposited, quartz is easier to clean, and quartz facilitates sample observation. However, Applicants have observed that the increased soot and carbon deposition on stainless steel results in more consistent, efficient, faster, and stable carbon nanotube growth. Without being bound by theory it has been indicated that, in conjunction with atmospheric operation, the CVD process occurring in the reactor is diffusion limited. That is, the carbon nanotube-forming catalyst is “overfed;” too much carbon is available in the reactor system due to its relatively higher partial pressure (than if the reactor was operating under partial vacuum). As a consequence, in an open system—especially a clean one—too much carbon can adhere to the particles of carbon nanotube-forming catalyst, compromising their ability to synthesize carbon nanotubes. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, reacts with the carbon nanotube-forming catalyst at a rate that does not poison the catalyst. Existing systems run “cleanly” which, if they were open for continuous processing, would produce a much lower yield of carbon nanotubes at reduced growth rates.

Although it is generally beneficial to perform carbon nanotube synthesis “dirty” as described above, certain portions of the apparatus (e.g., gas manifolds and inlets) can nonetheless negatively impact the carbon nanotube growth process when soot creates blockages. In order to combat this problem, such areas of the carbon nanotube growth reaction chamber can be protected with soot inhibiting coatings such as, for example, silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones.

Combined Catalyst Reduction and Carbon Nanotube Synthesis. In the carbon nanotube synthesis reactor disclosed herein, both catalyst reduction and carbon nanotube growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present disclosure due, at least in part, to the fact that carbon-containing feedstock gas is introduced at the center of the reactor, not the end as would be typical in the art using cylindrical reactors. The reduction process occurs as the fiber material enters the heated zone. By this point, the gas has had time to react with the walls and cool off prior to reducing the catalyst (via hydrogen radical interactions). It is this transition region where the reduction occurs. At the hottest isothermal zone in the system, carbon nanotube growth occurs, with the greatest growth rate occurring proximal to the gas inlets near the center of the reactor.

In some embodiments, when loosely affiliated fiber materials including, for example, tows or rovings are employed (e.g., a glass roving), the continuous process can include steps that spread out the strands and/or filaments of the tow or roving. Thus, as a tow or roving is unspooled it can be spread using a vacuum-based fiber spreading system, for example. When employing sized glass fiber rovings, for example, which can be relatively stiff, additional heating can be employed in order to “soften” the roving to facilitate fiber spreading. The spread fibers which contain individual filaments can be spread apart sufficiently to expose an entire surface area of the filaments, thus allowing the roving to more efficiently react in subsequent process steps. For example, a spread tow or roving can pass through a surface treatment step that is composed of a plasma system as described above. The roughened, spread fibers then can pass through a carbon nanotube-forming catalyst dip bath. The result is fibers of the glass roving that have catalyst particles distributed radially on their surface. The catalyzed-laden fibers of the roving then enter an appropriate carbon nanotube growth chamber, such as the rectangular chamber described above, where a flow through atmospheric pressure CVD or plasma enhanced-CVD process is used to synthesize carbon nanotubes at rates as high as several microns per second. The fibers of the roving, now having radially aligned carbon nanotubes, exit the carbon nanotube growth reactor.

It is understood that modifications which do not substantially affect the activity of the various embodiments of this invention are also included within the definition of the invention provided herein. Accordingly, the following Examples are intended to illustrate but not limit the present invention.

### Example 1

A mixture of epoxy resin and electrolyte was prepared in various proportions and cured either in the presence or absence of an electric field. Testing data is summarized in Table 1.

TABLE 1

| | Electric Field | | |
|---|---|---|---|
| | During Curing? | Electrolyte: | Normalized Ionic |
| Entry | (Y/N) | Polymer Resin | Conductivity (S/cm) |
| 1 | n/a | 100:0 | 9.2 × 10⁻³ |
| 2 | Y | 80:20 | 2.5 × 10⁻³ |
| 3 | N | 80:20 | 1.1 × 10⁻³ |
| 4 | N | 70:30 | 4.6 × 10⁻⁴ |
| 5 | N | 60:40 | 6.0 × 10⁻⁵ |
| 6 | Y | 50:50 | 5.5 × 10⁻⁴ |
| 7 | N | 50:50 | 1.9 × 10⁻⁵ |

As shown in Table 1, the maximum ionic conductivity was observed with pure electrolyte (entry 1). When the polymer resin was combined with the electrolyte, the electrical conductivity was reduced compared to entry 1, as expected. Comparing entries 2 and 3 and entries 6 and 7 with one another, however, it can be seen that the ionic conductivity was significantly higher when polymerization took place in the presence of an electric field. In the case of an 80:20 electrolyte:polymer resin mixture, applying an electric field during polymerization resulted in a 2.3-fold higher conductivity (entries 2 and 3). In the case of a 50:50 electrolyte:polymer resin mixture, applying an electric field during polymerization resulted in an even more pronounced effect with a 28.9-fold higher conductivity being observed for the sample polymerized in the presence of the electric field (entries 6 and 7). Comparing entries 4 and 7, it can be seen that applying an electric field during polymerization allowed the same order of magnitude conductivity to be maintained in the presence of 20% less electrolyte.

The effect on elastic stiffness was very pronounced when an electrolyte was included in the polymer matrix. At 100% polymer matrix, the elastic stiffness was 2110.5 MPa. When 50 wt. % electrolyte was included, the elastic stiffness dropped markedly to only 2.17 MPa. This behavior indicates that the ionically conductive polymer does not behave as an idealized cellular solid.

Although the invention has been described with reference to the disclosed embodiments, those of ordinary skill in the art will readily appreciate that these embodiments are only illustrative of the invention. It should be understood that various modifications can be made without departing from the spirit of the invention. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range is specifically disclosed. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is the following:

1. A method for making an ionically conductive polymer, the method comprising:
providing a mixture comprising an electrolyte and a polymer precursor; and
polymerizing the polymer precursor while applying an electric field to the mixture.

2. The method of claim 1, wherein the polymer precursor comprises an epoxy resin.

3. The method of claim 1, wherein the electrolyte comprises an organic electrolyte.

4. The method of claim 1, wherein the electrolyte comprises an inorganic electrolyte.

5. The method of claim 1, wherein the ionically conductive polymer has an electrical conductivity of at least about 10⁻⁵ S/cm.

6. The method of claim 5, wherein the ionically conductive polymer has a higher compressive stiffness than does an ionically conductive polymer made without applying an electric field while polymerizing the polymer precursor.

7. The method of claim 1, wherein an amount of the electrolyte ranges between about 10% and about 90% of the ionically conductive polymer by mass.

8. The method of claim 1, wherein the mixture further comprises a solvent.

9. The method of claim 1, wherein the mixture further comprises a filler material.

10. The method of claim 1, wherein applying an electric field to the mixture comprises applying an alternating current to the mixture.

11. The method of claim 1, wherein the electrolyte is present within conductive ion channels within the ionically conductive polymer.

12. A method for making an electrical device, the method comprising:
providing a layered structure comprising a first electrode layer, a second electrode layer, and a separator material layer disposed therebetween that is permeable to ions;
providing a mixture comprising an electrolyte and a polymer precursor;
infiltrating the layered structure with the mixture; and
polymerizing the polymer precursor while applying an electric field to the mixture.

13. The method of claim 12, wherein at least one of the first electrode layer or the second electrode layer comprises a carbon nanotube-infused fiber material.

14. The method of claim 12, wherein the polymer precursor comprises an epoxy resin.

15. The method of claim 12, wherein an amount of the electrolyte ranges between about 10% and about 90% of the mixture by mass.

16. The method of claim 12, wherein applying an electric field to the mixture comprises applying an alternating current to the mixture.

17. An ionically conductive polymer prepared by the process of claim 1 having an electrical conductivity of at least about 10⁻⁵ S/cm.

18. The ionically conductive polymer of claim 17, wherein electrolyte is present within conductive ion channels within the ionically conductive polymer.

19. The ionically conductive polymer of claim 17, wherein the electrolyte comprises an organic electrolyte.

20. The ionically conductive polymer of claim 17, wherein the electrolyte comprises an inorganic electrolyte.

21. The ionically conductive polymer of claim 17, wherein an amount of the electrolyte ranges between about 10% and about 90% of the ionically conductive polymer by mass.

22. The ionically conductive polymer of claim 17, wherein the polymer precursor comprises an epoxy resin.

23. The ionically conductive polymer of claim 17, wherein the mixture further comprises a filler material.

24. The ionically conductive polymer of claim 17, wherein the ionically conductive polymer has a higher compressive stiffness than does an ionically conductive polymer made without applying an electric field while polymerizing the polymer precursor.

25. An electrical device comprising the ionically conductive polymer of claim 17.

26. An electrical device comprising:
a layered structure comprising a first electrode layer, a second electrode layer, and a separator material layer disposed therebetween that is permeable to ions; and
an ionically conductive polymer infiltrating the layered structure;
wherein the ionically conductive polymer comprises an electrolyte and a polymer matrix that has been polymerized in the presence of an electric field.

27. The electrical device of claim 26, wherein at least one of the first electrode layer or the second electrode layer comprises a carbon nanotube-infused fiber material.

28. The electrical device of claim 26, wherein the polymer matrix comprises an epoxy resin.

29. The electrical device of claim 26, wherein an amount of the electrolyte ranges between about 10% and about 90% of the ionically conductive polymer by mass.
